(19) United States
(12) Patent Application Publication
(10) Pub. No.: US 2008/0128499 A1
(43) Pub. Date: Jun. 5, 2008

(54) Programmable trigger handle for handheld devices

(75) Inventors: Ralph R. Chen, Bothell, WA (US); Robert Chen, Everett, WA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 11/633,835

(22) Filed: Dec. 5, 2006

(51) Int. Cl. G06K 7/01; G06K 7/10; G06K 7/08

(52) U.S. Cl. 235/444; 235/472.02; 235/449; 235/462.46

(57) ABSTRACT

A handle for receiving a portable data collection terminal includes a trigger mechanism activatable to provide a trigger signal to the portable data collection terminal. A trigger functionality selector has at least first and second states representing different functions of the portable data collection terminal that are to be activated by the trigger signal.

### CROSS-REFERENCE TO RELATED APPLICATION(S)

None.

### BACKGROUND OF THE INVENTION

The present invention relates to a programmable trigger for activating various functions associated with a handheld device, such as barcode or image scanning, radio frequency identification (RFID), voice communications, data communications, global positioning system (GPS) functions, or others.

Handheld computing and data collection devices are commonly used in a number of different applications. In many applications, a handheld device is equipped with one or more data collection functions that allow the device to acquire information from an external source. Examples of equipment for performing these functions are barcode readers, image scanners, RFID readers, voice communication devices (walkie-talkies, voice over IP, and others), data communication devices, GPS devices, and others.

These types of handheld devices are useful for a number of purposes. When the devices are used for data collection, it is often useful for a handle accessory to be employed for comfort and ease of use of the device. The handle accessory is typically configured with a trigger for activating a data collection function of the device. For handheld devices that do not have integrated data collection capability, the handle may be equipped with separate data collection functionality that is activated by a trigger, with the results of the data collection being communicated to the handheld device.

As the demands on handheld devices increase, it is desirable for devices to be increasingly versatile and to have the capability of performing many different functions with as few accessories as possible.

### BRIEF SUMMARY OF THE INVENTION

The present invention provides a handle for receiving a portable data collection terminal. The handle includes a trigger mechanism activatable to provide a trigger signal to the portable data collection terminal. A trigger functionality selector has at least first and second states representing different functions of the portable data collection terminal that are to be activated by the trigger signal.

### BRIEF DESCRIPTION OF THE DRAWINGS

FIG. 1 is a diagram illustrating a programmable trigger handle according to a first embodiment of the present invention.

FIG. 2 is a block diagram illustrating the functional components of a handle and a terminal that allow selective programming of the functions of a trigger of the handle in one embodiment of the invention.

FIG. 3 is a block diagram illustrating the functional components of a handle and a terminal that allow selective programming of the functions of a trigger of the handle in another embodiment of the invention.

### DETAILED DESCRIPTION

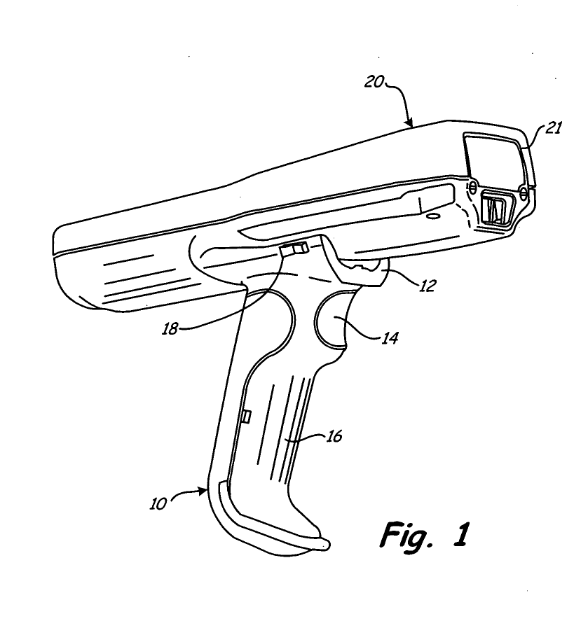

FIG. 1 is a diagram illustrating programmable trigger handle 10 according to a first embodiment of the present invention. Handle 10 includes device holder 12, trigger 14, handle body 16, and switch 18. Handle 10 is shown in FIG. 1 holding handheld data collection and computing terminal 20, which in the embodiment shown includes integral barcode scanning capability with an internal scanning engine through scanning window 21

Device holder 12 is a portion of handle 10 that is configured to receive a handheld terminal such as terminal 20. Device holder 12 receives terminal 20 mechanically by the mating configuration of device holder 12 and the bottom surface of terminal 20, and also makes a communicative connection between handle 10 and terminal 20 (e.g., electrically, magnetically, by a wireless communication interface utilizing radio frequency communication, infrared communication or optical communication, for example, or by other means). The manner of receiving terminal 20 mechanically and communicatively is known in the art.

The functions performed by trigger 14 are programmable. In a first embodiment, selective positioning of switch 18 on handle 10 controls the function performed by trigger 14. For example, in a first position of switch 18, trigger 14 may be operable to initiate laser scanning by terminal 20, while in a second position of switch 18, trigger 14 may be operable to initiate reading of an RFID tag by an RFID reader in terminal 20. In some versions, switch 18 may have three or more positions to provide additional options for functions initiated by trigger 14. Examples of functions that may be initiated by trigger 14 include image scanning, voice communications, data communications, global positioning system (GPS) functions, or others.

In a second embodiment, programming of terminal 20 may be performed in order to control the functions performed by trigger 14 of handle 10. The programming may be done by the manufacturer, or in some versions may be performed dynamically by a user. For example, a software or hardware button may be provided on terminal 20 to select a certain function for trigger 14, such as a button labeled “scan” and a button labeled “RFID” in order to allow a user to select between those functions. Other programming variations will be apparent to those skilled in the art.

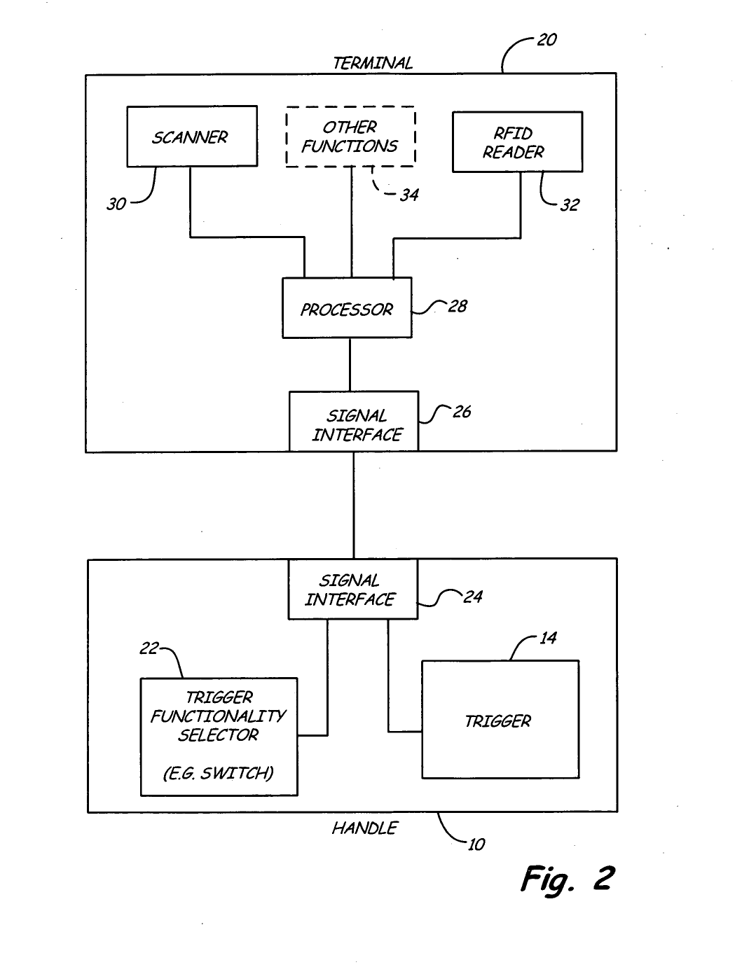

FIG. 2 is a block diagram illustrating the functional components of handle 10 and terminal 20 that allow selective programming of the functions of trigger 14 of handle 10 in one embodiment of the invention. Handle 10 functionally includes trigger 14, trigger functionality selector 22, and signal interface 24. Trigger functionality selector 22 may in one example be switch 18 shown in FIG. 1. When trigger 14 is activated, a signal is sent to signal interface 24. In addition, trigger functionality selector 22 also sends a signal to signal interface 24 that is representative of the programmed function of trigger 14. The signals from trigger 14 and from trigger functionality selector 22 are transmitted from handle 10 to terminal 20, where they are received by signal interface 26. The signals are then passed on to processor 28, which identifies the presence of an incoming trigger signal as well as the state of the signal from trigger functionality selector 22. Processor 28 then sends a signal to initiate operation of scanner 30, RFID reader 32, or some other data collection mechanism or function 34 based on the trigger signal and the state of the signal from trigger functionality selector 22.

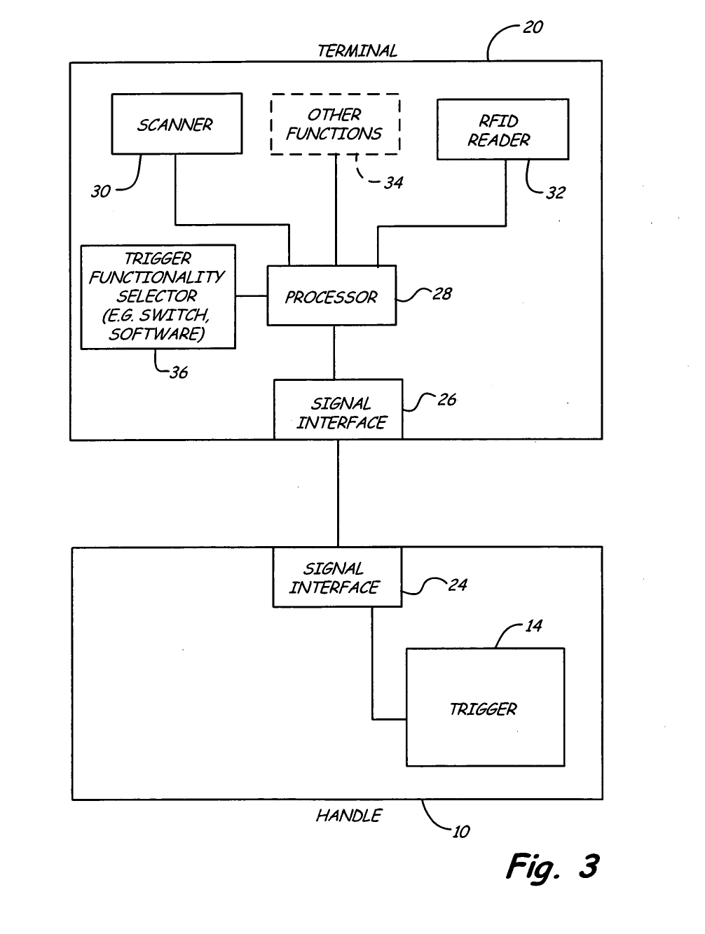

FIG. 3 is a block diagram illustrating the functional components of handle 10 and terminal 20 that allow selective programming of the functions of trigger 14 of handle 10 in another embodiment of the invention. The embodiment of FIG. 3 is similar to the embodiment of FIG. 2, except that trigger functionality selector 36 is provided with terminal 20 instead of trigger functionality selector 22 that is provided with handle 10 in the embodiment of FIG. 2. When trigger 14 is activated, a signal is sent to signal interface 24 and transmitted from handle 10 to terminal 20, where it is received by signal interface 26. The signal is then passed on to processor 28, which identifies the presence of an incoming trigger signal. Processor 28 also receives a signal from trigger functionality selector 36 that indicates the programmed function of trigger 14. Processor 28 then sends a signal to initiate operation of scanner 30, RFID reader 32, or some other data collection mechanism 34 based on the trigger signal and the state of the signal from trigger functionality selector 36.

As described above, the present invention provides a handle with a trigger having programmable functions for operating certain capabilities of a portable data collection terminal received by the handle. The programming of the trigger may be achieved by manipulation of the handle (such as by a physical mechanism such as a switch), by manipulation of the portable data collection terminal (such as by programming and operation of hardware or software buttons), or by other programming of software associated with the handle, the terminal, or both. The invention therefore allows a user to comfortably activate a number of different capabilities of the terminal with a single, ergonomically located trigger.

Although the present invention has been described with reference to preferred embodiments, workers skilled in the art will recognize that changes may be made in form and detail without departing from the spirit and scope of the invention.

What is claimed is:

1. A handle for receiving a portable data collection terminal, the handle comprising:
a trigger mechanism activatable to provide a trigger signal to the portable data collection terminal; and
a trigger functionality selector having at least first and second states, the first and second states representing different functions of the portable data collection terminal that are to be activated by the trigger signal.

2. The handle of claim 1, wherein the trigger functionality selector is a switch having a first position corresponding to the first state and a second position corresponding to the second state.

3. The handle of claim 1, wherein the first state represents a barcode scanning function of the portable data collection terminal and the second state represents a radio frequency identification (RFID) function of the portable data collection terminal.

4. The handle of claim 1, wherein the trigger signal provided by the trigger mechanism is communicated to the portable data collection terminal via an interface between the handle and the portable data collection terminal, the interface being selected from the group consisting of an electrical interface, a magnetic interface, and a wireless communication interface.

5. The handle of claim 1, wherein the trigger signal provided by the trigger mechanism is communicated to the portable data collection terminal via a wireless communication interface between the handle and the portable data collection terminal, the wireless communication interface being selected from the group consisting of a radio frequency communication interface, an infrared communication interface, and an optical communication interface.

6. The handle of claim 1, wherein the trigger functionality selector has at least a third state representing another different function of the portable data collection terminal that is to be activated by the trigger signal.

7. The handle of claim 1, wherein the different functions of the portable data collection terminal are selected from a group consisting of barcode or image scanning, radio frequency identification (RFID), voice communication, data communication, and global positioning system (GPS) functions.

8. A data collection system comprising:
a portable data collection terminal having a plurality of different functions;
a handle for receiving the portable data collection terminal, the handle comprising a trigger mechanism activatable to provide a trigger signal to the portable data collection terminal; and
a trigger functionality selector having at least first and second states representing the plurality of different functions of the portable data collection terminal that are to be activated by the trigger signal.

9. The data collection system of claim 8, wherein the trigger functionality selector is operable by manipulating the handle.

10. The data collection system of claim 9, wherein the trigger functionality selector comprises a switch having a first position corresponding to the first state and a second position corresponding to the second state.

11. The data collection system of claim 8, wherein the trigger functionality selected is operable by manipulating the portable data collection terminal.

12. The data collection system of claim 11, wherein the trigger functionality selector comprises a programmable button operatable from the portable data collection terminal.

13. The data collection system of claim 8, wherein the first state represents a barcode scanning function of the portable data collection terminal and the second state represents a radio frequency identification (RFID) function of the portable data collection terminal.

14. The data collection system of claim 8, wherein the trigger signal provided by the trigger mechanism is communicated to the portable data collection terminal via an interface between the handle and the portable data collection terminal, the interface being selected from the group consisting of an electrical interface, a magnetic interface, and a wireless communication interface.

15. The data collection system of claim 8, wherein the trigger signal provided by the trigger mechanism is communicated to the portable data collection terminal via a wireless communication interface between the handle and the portable data collection terminal, the wireless communication interface being selected from the group consisting of a radio frequency communication interface, an infrared communication interface, and an optical communication interface.

16. The data collection system of claim 8, wherein the different functions of the portable data collection terminal are selected from a group consisting of barcode or image scanning, radio frequency identification (RFID), voice communication, data communication, and global positioning system (GPS) functions.

17. A method of operating a portable data collection terminal to perform a desired function selected from a plurality of different functions using a handle that receives the portable data collection terminal, the method comprising:
manipulating a trigger functionality selector to select the desired function from the plurality of different functions;
activating a trigger mechanism on the handle to provide a trigger signal to the portable data collection terminal that operates the data collection terminal to perform the desired function.

18. The method of claim 17, wherein manipulating the trigger functionality selector comprises setting a state of a switch on the handle that corresponds to the desired function.

19. The method of claim 17, wherein manipulating the trigger functionality selector comprises operating a programmable button of the portable data collection terminal to select the desired function.

20. The method of claim 17, wherein the plurality of different functions of the portable data collection terminal are selected from a group consisting of barcode or image scanning, radio frequency identification (RFID), voice communication, data communication, and global positioning system (GPS) functions.
